(19) United States
(12) Patent Application Publication
(10) Pub. No.: US 2003/0039712 A1
(43) Pub. Date: Feb. 27, 2003

(54) Extruding device

(76) Inventor: Jaromir Friedrich, Edmonton (CA)

Correspondence Address: SELITTO, BEHR & KIM, 203 MAIN STREET, METUCHEN, NJ, 08840, US

(21) Appl. No.: 10/228,179

(22) Filed: Aug. 26, 2002

(30) Foreign Application Priority Data
Aug. 27, 2001 (CA) 2,356,235

(51) Int. Cl. B29C 47/52

(52) U.S. Cl. 425/204; 425/567; 425/308

(57) ABSTRACT

A plastic material extruder combines the features of a generally flat rotatable disc and a generally flat opposed stator. At least one of the two is heated by heating elements. The two define a processing gap into which a hopper for feeding a plastic material mixture is discharged. The rotor and the stator develop a high shear force which further heats up the processed mixture in addition to the heating delivered by the heating elements. At the center of the disc/stator assembly, an axial force developing device such as a ram or a feed screw or screws is adapted to further compress and extrude a mixture of the thermoplastic components and thermosetting components, the latter being comprised of crumbled pieces of used tires. The extruder is shown in two embodiments, one injecting the processed alloy into a mold, the other producing pellets of the processed alloy.

The present invention relates to extruders for plastic material.

More particularly, but not exclusively, the invention is intended for use in processing a mixture of a thermoplastic and a thermosetting material. In a particularly preferred application, the thermosetting material is presented by crumbled pieces made from used tires.

In one application to which the present invention relates, the crumbled pieces of rubber from used tires are to be mixed with a thermoplastic material to form and alloy-like mixture capable of being injected into a mold or the like.

One problem with attempting to mix a thermoplastic material with thermosetting particles such as crumpled used tire particles is that the mixing can only be effected at elevated temperatures. In order to achieve the desired temperature regime, the mixture from which an alloy is to be made is to be subjected to a shear force generating environment that is efficient enough to simultaneously create sufficient additional heat and to homogenize the components.

A disc extruder for extruding plastic has been described long ago, but to the best knowledge of the present applicant, never put into practice. It basically comprised a rotary disc or rotor which co-operates with a stator having a heated counter-face forming a narrow gap with the rotor. The working mixture was proposed to be introduced between the disc and the stator and subjected, by the stator, to a shear force.

Reference may be had, for instance to U.S. Pat. No. 3,689,181 (Maxwell), to U.S. Pat. No. 3,712,783 (Maxwell), to U.S. Pat. No. 3,790,328 (Maxwell) and U.S. Pat. No. 6,352,425 (Lupke et al.).

The basic principle of a disc extruder utilizes the principle that when a visco-elastic material is subjected to a shearing force between two disc surfaces rotatable relative to each other, a centripetal force results which forces the material towards the centre of the discs and can be discharged through a discharge opening provided in one of the discs.

Viewed from the standpoint of the present invention, the extruders referred to above have several disadvantages and are therefore not suitable for operating with a mixture of thermoplastic and thermosetting particles. In particular, the devices described do not provide exit pressures which are often required for injection molding of the thermoplastic/thermosetting mixture. This is mainly due to the fact that the flow of molten material has to change the direction of its flow from a generally radially inward direction to an axially outward discharge.

In the Maxwell '181 patent there are two radial discs rotatable relative to each other, of which one is coincident with a wall of a cup-shaped chamber and serves as a stator, while the opposed disc is rotatably driven relative to the stator. Even though the reference purports to increase the centripetal effect, the discharge pressure at the outlet provided at the centre of the chamber is insufficient, particularly when working with a mixture of a thermoplastic and thermosetting material.

The Maxwell '783 patent provides a conical rotor and a conical stator co-operating much in the fashion of the previously described reference. The conical rotor requires more axial space than the flat disc-shaped arrangement of the previous reference. Also, the Maxwell '783 patent, like the previous reference, does not provide means for a sufficient exit pressure for injection molding of the processed material.

Maxwell '328 suffers from the same drawbacks as the previously described embodiments. Besides, it unduly increases the axial width of the disc portion by including at its periphery and near the feeding opening, a spiral member which is adapted to force the incoming mixture axially, towards the mutually rotated disc surfaces.

The Lupke et al. reference, which issued relatively recently, provides a further indication that the conical disc-shaped processing surfaces movable relative to each other. The device is further increased in axial length by an integrally formed hollow tubular portion which provides an outlet for the material which has passed between adjacent conical processing surfaces.

It is also known, e.g. from U.S. Pat. No. 3,756,573 (Sponseller) to locate a conical rotor and a stator between two conveyor screw—type feeding mechanism and another screw disposed downstream of the rotor/stator assembly. The device is very complex in structure and requires a relatively large space since the entire downstream screw is disposed axially away from

It is an object of the present invention to provide a device which is capable of securing the heating/mixing regime desired for the above purpose while at the same time permitting a generally simultaneous high pressure extrusion of the resulting mixture out of the device. It is another object of the present invention to provide the device which is simple in structure and thus less expensive to produce, while requiring a relatively small space in a production plant.

According to the invention, an injection device is provided which comprises a radial disc-shaped stator and a rotatably driven radial disc-shaped rotor facing the stator to define an annular mixing gap between the two. A hopper is provided above the mixing gap for feeding into the gap a mixture which is comprised of a selected thermoplastic material, for instance, in the form of pellets, and crumbled pieces of rubber produced from used tires or some other thermosetting material. At least the stator surface is heated. The rotary motion of the rotor relative to the stator subjects the mixture to an intensive shearing force which increases the temperature of the processed mixture substantially above the temperature provided by the heated stator and/or rotor. Thus, the increased temperature is sufficient to provide a thorough interaction and homogenization of the two components to produce a thermoplast-thermoset alloy which is at the liquid state at the discharge part of the disc, the discharge part being the inner part of the disc/stator due to the centripetal forces developed by the shearing action between the stator and rotor. In accordance with the invention, an axial force developing mechanism is disposed at the center of the stator/rotor section for an immediate further injecting the processed material into a form or the like.

The axial force developing mechanism is, in one embodiment, an axially reciprocable ram adapted to force the alloy through a discharge port into a dye. In another embodiment, the axial force developing mechanism is a single or multiple feed screw arrangement which may be operatively associated with a perforated end disc. The processed material is then forced to flow through the openings in the disc to form the desired pellets or other form of solid particles of the final alloy.

In the drawings:

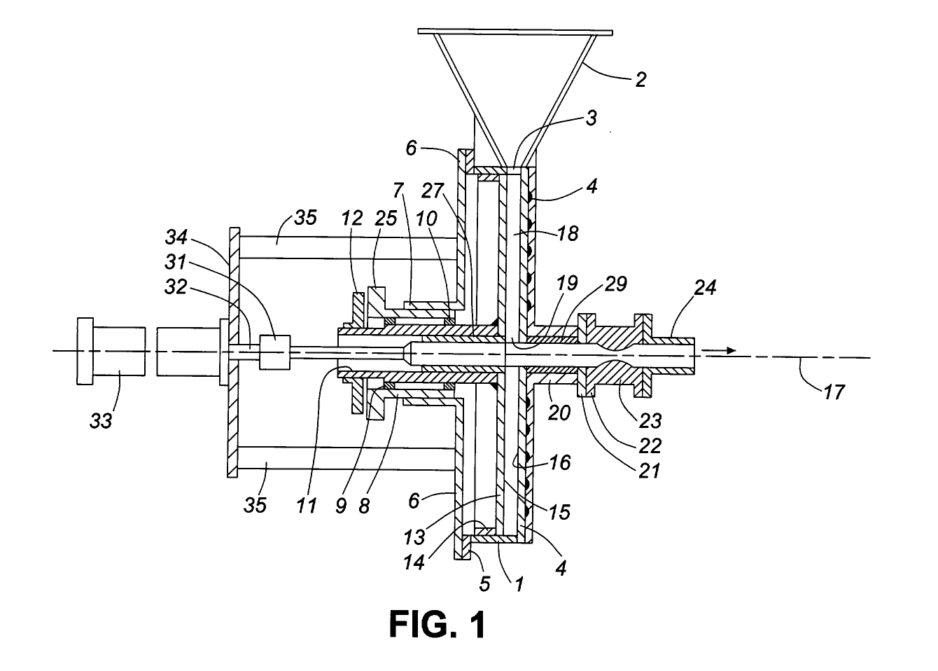

FIG. 1 is a diagrammatic sectional view showing one embodiment of the inventive apparatus; and

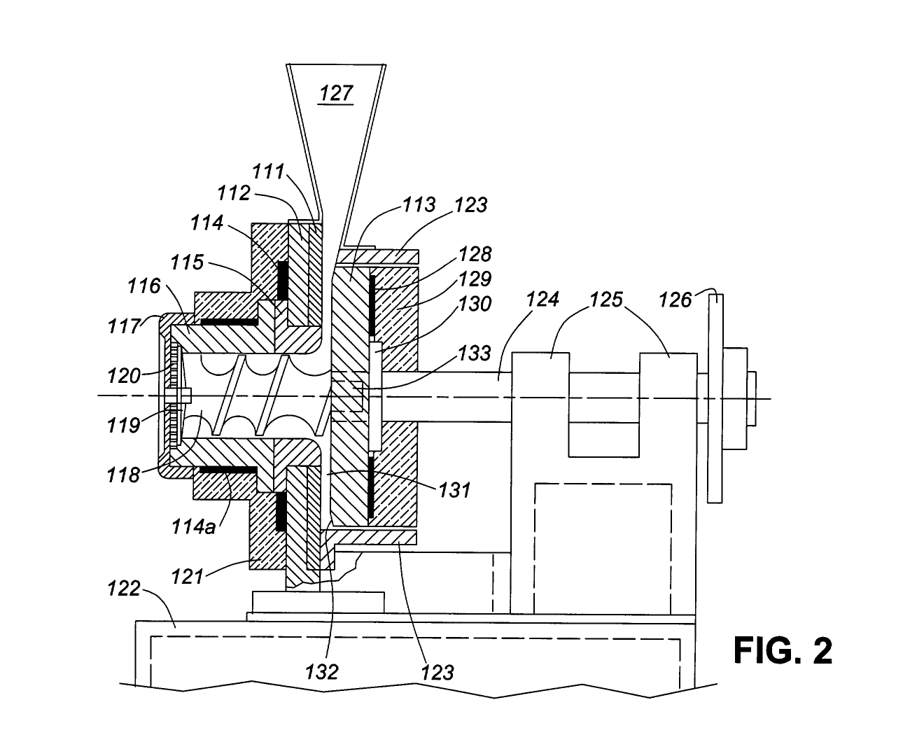

FIG. 2 is a diagrammatic sectional view showing another embodiment of the inventive apparatus.

It will be appreciated that the embodiments shown present only exemplary versions which can be modified to a greater or lesser degree as may be required.

Turning now to FIG. 1, the apparatus shown comprises a cup shaped chamber 1 provided with particulate matter feeding means, in the embodiment shown, a hopper 2 at the upper part of the chamber, which communicates, via a feed inlet 3 in the cylindric wall of the chamber 1, with the interior of the chamber 1 as will be described. The chamber 1 is provided, at its right-hand end with a heating element 4. The opposite end of the chamber 1 has a flange 5 which provides connection means for a cover 6 which is integrally formed with a rearwards extending tubular portion 7. The above described elements are fixedly secured and stationary relative to a frame (not shown) of the device.

Threaded into the tubular portion 7 is an outwardly threaded sleeve 8. Mounted rotatably with respect to the sleeve 8 on bearings 9, 10 is a tubular shaft 11 provided, in the embodiment shown, with a drive sprocket 12. The sprocket 12 is to be understood to present only one of many other equivalent drive means for rotatably driving the disc 13. The right-hand end of the shaft 11 is fixedly secured to a radial disc 13 comprising a short cylindric section 14 and a generally radial, annular face 15 which is parallel with the inside annular face 16 coincident with the bottom of the cup-shaped chamber 1. It is preferred that both the annular face 15 and the annular face 16 be radial, but small deviations to say, a shallowly conical shape having an apex angle of about 175° is also acceptable.

The radial disc and the bottom wall of the chamber thus form a first and a second mixing disc. The mixing discs present an embodiment of the arrangement wherein the discs are rotatable relative to each other since the chamber 1 is stationary and the disc 13 is rotatable about the axis 17. The faces 15 and 16 of the mixing discs define therebetween a mixing gap 18 which, like the faces 15 and 16, is annular and thus has a radially outer portion near the feed inlet 3, and a radially inner portion 19 near an outlet tube 20 having, at its discharge end a flange 21 compatible with a flange 22 of a back flow valve 23 and connected to it by bolts (not shown). The valve 23, in turn, is connected in similar fashion to the downstream mold die 24.

As already mentioned, the tubular portion 7 is threaded at its inner surface to threadably receive the sleeve 8 having an enlarged diameter end portion 25. The right hand end of the tubular shaft 11 is fixedly secured to the rotor 13. At the right hand end portion of the shaft 11, an inner lining 27 guides a ram 28. The inside of the outlet tube 20 is likewise provided with a lining 29. The rod 30 of the ram 28 is connected by a coupling 31 with the piston rod 32 of a hydraulic cylinder 33. The cylinder 33 (which is a preferred embodiment of what generally can be referred to as “second driving means” additional to the “first driving means” presented by the sprocket 12) is fixedly mounted on a base plate 34 supported by a plurality of supports 35 at a predetermined distance from the outer face of the cover 6.

The outer diameter of the mixing discs 13, 16 may vary within a large range, depending on the desired throughput. Typically, the width of the mixing gap 18 is determined by a formula

B=Ki R (1)

wherein

Ki is a constant for a given relative rotation velocity and

R is the radius of the mixing gap.

It follows from the above that the optimum width of the gap 18 having an outer diameter of about 30″ would be about 2.1″. The typical speed of a device of this size would be slightly over 100 rpm which would result in a throughput of about 1000 lbs per hour.

In operation, the apparatus is started by driving the rotor 13 by the first drive means (the sprocket 12) at a given speed. At the same time, the heating element 4 is actuated. The mixture of a thermoplastic and thermosetting material is fed through the hopper 2 into the gap 18 between the rotor 13 and stator 16 where it is subjected to high heat and a shear force. The shear force still further increases the heat of the mixture. At the same time, the working mixture is intermixed and homogenized into an alloy, while advancing, due to the centripetal motion developed by the relative movement between the rotor 13 and stator 16, toward the center of the rotor/stator assembly. Reciprocating motion of the ram 28 then further forces the alloy past the back flow valve 23 and into a mold die 9.

The second embodiment, shown in FIG. 2 presents a virtually identical portion of the mutually rotatable discs in that the two discs are again formed by a rotor and a stator. Reference number 111 shows the face of a stator 112. The rotor is designated with number 113.

The stator 112 is heated by a heating element 114. The inner portion of the gap 131 between the rotor and stator terminates at an extrusion port 115 which coincides with an inlet port of a screw barrel 116. The barrel 116 is provided with a cylindric heating element 114a. The outer portion of the gap 131 is in the region of bevel 132 provided in the face of the rotor 113. An annular nut 117 at the discharge end of the barrel 116 secures a perforated plate 120 to the barrel 116 and thus to the the port 115. The plate 120 has a central opening which supports the discharge end of a screw 118. The opposed end of the screw 118 is threaded into the rotor 113 at 133 near the port 115 The discharge end of the screw 118 carries, inside of the plate 120, a cutter 119 which frictionally engages the inner surface of the perforated plate 120. The entire feed screw and barrel assembly is provided with insulation 121. Number 122 designates a base to which the particular device is secured.

The stationary barrel housing of the rotor 113 is designated with number 123. The rotor 113 is fixedly secured to a drive shaft 124 suitably mounted in bearings 125. The securement is effected via a flange 130 and bolts which are not specifically shown in the drawing. The shaft 124 is provided, at its end remote from the disc 113, with a sprocket wheel 126 which forms a part of a drive mechanism not shown in detail.

It will be appreciated that, in this embodiment, the sprocket 126 drives both the rotor 113 and, through the threaded connection 133, the feed screw 118. Therefore the single sprocket provides both means for driving the rotor and means for driving the axial feeding means, i.e. the feed screw.

The hopper is designated with number 127. In this embodiment, both the stator 112 and the rotor 113 are heated, the heating system of the rotor being shown with number 128 and being provided with a suitable thermal insulation layer 129.

The operation of the rotor/stator portion of the second embodiment is virtually identical with that of the first embodiment. The difference is in that the axial feed of the homogenized mixture is effected by a feed screw and that, instead of forcing the alloy into a mold, the mixture is forced through openings in the perforated disc 120 which co-operates with the cutter 119 to produce pellets of the homogenized mixture.

It will be appreciated that more or less substantial modifications of the embodiments described can be made without departing from the scope of the present invention. As an example, more than one feed screws can be used or the ram mechanism may have a different configuration.

1. Apparatus for feeding visco-elastic plastic material, particularly comprised of a thermoplastic particles and thermosetting particles such as crumbled rubber from used tires, the apparatus comprising, in combination,
(a) a circular cup-like chamber having a longitudinal axis;
(b) a first mixing disc and a second mixing disc, said first and second mixing discs being disposed within said chamber for rotation relative to each other;
(c) first drive means for rotatably driving one of said first and second mixing discs about said axis, relative to the other one of said first and second mixing discs;
(d) said mixing discs having each an annular mixing face, the mixing faces being turned towards each other at a spacing which defines an annular mixing gap therebetween, said mixing gap having a radially outer portion and a radially inner portion;
(e) particulate mixture feeding means in said chamber disposed at said radially outer portion of said mixing gap and adapted to feed the mixture into the gap;
(f) axial feeding means at said radially inner portion of said mixing gap;
(g) second drive means for driving said axial feeding means in an alignment with said axis; and
(h) a discharge nozzle operatively associated with said axial feeding means to discharge said material from said extruder

2. The apparatus of claim 1 wherein one of the first and second mixing discs is rotatable relative to the chamber.

3. The apparatus of claim 1 wherein one of the first and second mixing discs is stationary relative to the chamber.

4. The apparatus of claim 1 wherein the axial feeding means is a reciprocably driven ram coaxial with the axis and adapted to intermittently force said material through said nozzle.

5. The apparatus of claim 1 wherein the axial feeding means is feed screw means.

6. The apparatus of claim 5 wherein the feed screw means is a feed screw coaxial with said axis.

7. The apparatus of claim 1 in which the width of said gap is linearly related to the outer diameter of said radially outer portion of the gap, in accordance with the general formula:
B=Ki R
30>R>
wherein:
R is the radius of the radially outer portion of the gap; and Ki is a constant dependent on a given relative rotation velocity between the mixing rotors.

8. The apparatus of claim 6 wherein the feed screw means is non-rotatably coupled with the rotatably driven disc, whereby said first driving means and said second driving means is formed by a single drive operatively associated with a drive shaft non-rotatably secured to the rotatably driven disc.
